(19) United States
(12) Patent Application Publication
(10) Pub. No.: US 2024/0303743 A1
(43) Pub. Date: Sep. 12, 2024

(54) COMPUTER SYSTEMS FOR DURATION-DEPENDENT HYBRID GENERATION

(71) Applicant: Joshua Brooks, Columbus, GA (US)

(72) Inventor: Joshua Brooks, Columbus, GA (US)

(21) Appl. No.: 18/596,142

(22) Filed: Mar. 5, 2024

Related U.S. Application Data
(60) Provisional application No. 63/488,620, filed on Mar. 6, 2023.

(51) Int. Cl. G06Q 40/06

(52) U.S. Cl. CPC G06Q 40/06

(57) ABSTRACT

One embodiment of a computer-implemented method may include receiving one or more target parameters associated with a client, where the one or more target parameters may be based on one or more factors. The method may further include determining a risk tolerance measurement for the client associated with achieving the target parameter(s). The method may further include determining an optimal source quantity associated with achieving the target parameter(s) based on the risk tolerance measurement. The method may further include determining optimal allocation parameters for allocating the optimal source quantity. The method may further include generating a user interface including one or more duration-dependent hybrids, where the one or more duration-dependent hybrids may include one or more product offerings based at least in part on the optimal source quantity and the optimal allocation parameters.

### CROSS-REFERENCE TO RELATED APPLICATION

This application claims the benefit of and priority to U.S. Provisional Patent Application No. 63/488,620, filed Mar. 6, 2023, entitled “COMPUTER SYSTEMS FOR DURATION-DEPENDENT HYBRID GENERATION,” the contents of which is hereby incorporated herein by reference in its entirety.

### BACKGROUND

As individuals approach their elderly years, they may face a garden variety of challenges related to their health, wealth, and general well-being. The longer individuals live, the more potential challenges they may face with respect to the above-mentioned factors. Sufficiently planning ahead for some of these challenges may be difficult as the age of mortality for individuals may vary widely.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 depicts an example computing system that may be implemented with the techniques presented herein for duration-dependent hybrid generation, according to one or more embodiments of the present disclosure.

FIGS. 2A-2C depict various stochastic models associated with an expected rate of return of various vehicles, according to one or more embodiments of the present disclosure.

FIG. 3 depicts an exemplary method for duration-dependent hybrid generation, according to one or more embodiments of the present disclosure.

FIG. 4 depicts an example user interface rendered on a client device, according to one or more embodiments of the present disclosure.

FIG. 5 depicts another example user interface rendered on a client device, according to one or more embodiments of the present disclosure.

FIG. 6 depicts an interactive chart that may be dynamically updated with a scroll bar, according to one or more embodiments of the present disclosure.

FIG. 7 depicts an example machine-learning training flow chart, according to one or more embodiments of the present disclosure.

FIG. 8 is a schematic block diagram that provides one example illustration of the server of FIG. 1, according to one or more embodiments of the present disclosure.

### DETAILED DESCRIPTION

For a user, exhausting accumulated resources is a primary concern when planning for cessation of resource acquisition. Termed “longevity risk,” users often ask whether they will exhaust their accumulated resources. However, even the most experienced advisors may have a difficult time adequately answering this question due to the many different variables that may be involved. To combat the fear of outliving accumulated resources, users may seek to conserve resources by investing in low growth, low risk resource placements or perhaps try to beat the odds and gamble their accumulated resources in high risk resource placements, hoping to make up for lost ground.

A common solution used by advisors to solve this problem for their clients is called the 4% rule. For example, the 4% rule is a guideline used in resource planning to determine a sustainable withdrawal rate from an accumulated resources account. The 4% rule suggests that individuals can withdraw approximately 4% of their accumulated resources in the first year of retirement and then add an increase factor to that amount each year thereafter. This method may give individuals a fairly good assurance that their resources may last at least 30 years. However, the 4% rule is not exactly a scientific approach tailored to meeting a user's goals and may be prone to pitfalls such as living beyond 30 years after cessation of resource acquisition, resource exchange variability, market variability, and others. Additionally, blindly investing in low risk or high risk resource placements may also not be an ideal way for individuals to meet their goals.

Therefore, one or more embodiments of the present disclosure may provide a computing system for entities (e.g., advisors, institutions, etc.) for assisting their clients in obtaining a duration-dependent hybrid. The computing system may be configured to provide the duration-dependent hybrid which may include customized product offerings that may be designed to meet target parameters (e.g., target cessation of resource acquisition parameters) for each individual client. The computing system may be configured to receive inputs, such as client demographics data, risk tolerance measurement data, and target cessation of resource acquisition parameter data, among others, and output product offerings that may include an optimal source quantity (e.g., dollars or other currencies) and different options for allocating the optimal source quantity for achieving the client's goals. For example, the different options for allocating the source quantity may include allocating via a first resource placement vehicle (e.g., bonds, stocks, mutual funds, etc.), a second resource placement vehicle (e.g., annuities such as fixed annuities, variable annuities, indexed annuities, deferred annuities, etc.) or a blend of the first resource placement vehicle and the second resource placement vehicle.

For example, the computing system may provide the duration-dependent hybrid that may be designed to meet a client's desired annual resource consumption metric upon cessation of resource acquisition with the least amount of source quantities invested. One or more embodiments may enable the entities to adjust the product offerings, to suit the desires of the client. After agreement by the client regarding desired balance of investments and annuities, one or more embodiments may provide a guide for the entities to assist the clients in placing the source quantities in a model portfolio as well as proposals from selected annuity providers. One or more embodiments may use a variety of investment and annuity databases that may be customized based on advisory processes, including connecting directly with CANNEX to obtain latest annuity premiums and ratings from all annuity carriers in the United States. One or more embodiments may include software as a service (SaaS) tools provided for the entities so that their clients may easily view cessation of resource acquisition products suited to their goals.

The approach outlined above offers various advantages over conventional methods of cessation of resource acquisition planning to meet an individual's goals. For example, one or more embodiments may be computationally efficient in providing an optimized ratio of annuities and investments with a total amount of funds that may need to be invested to theoretically meet a client's cessation of resource acquisition resource goal.

As one skilled in the art will appreciate in light of this disclosure, certain embodiments may be capable of achieving certain advantages, including some or all of the following: (1) reducing computer resource utilization (e.g., memory consumption, processor utilization, network transfer, etc.) by reducing reliance on conventional computational methods such as Monte Carlo engines and algorithms in determining required source quantities and allocation parameters for the determined source quantities that may achieve a client's target parameters (e.g., target cessation of resource acquisition parameters), which may be achieved through implementation of stochastic calculus tools and machine-learning models and algorithms; (2) improving the functioning and reliability of a computing system through use of machine-learning models to predict source quantities required and allocation parameters for the source quantities, to achieve a client's target parameters, where the machine-learning models may be trained with data objects marked as including client demographics data, risk tolerance measurement profile, and desired annual resource consumption metric upon cessation of resource acquisition, and where use of the machine-learning models with the marked data objects may improve the sensitivity and precision of the computing system developed for duration-dependent hybrid generation; and (3) improving the user experience in interacting with a computing system by providing the entities and their clients with a streamlined product offerings page, with interactive charts and scroll bars that enable clients to view and select a variety of products that are commensurate with specified target parameters.

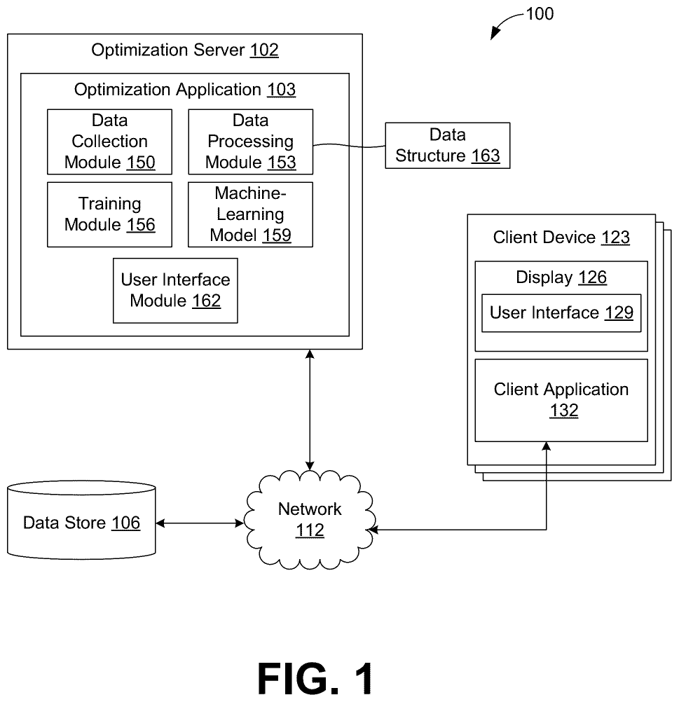

Referring now to the drawings, FIG. 1 depicts an example computing system 100 that may be implemented with the techniques presented herein for duration-dependent hybrid generation, according to one or more embodiments of the present disclosure. For example, the computing system 100 may be used by entities to provide product offerings to their clients for achieving a client's target parameters (e.g., target cessation of resource acquisition parameters) that include resource consumption goals. As depicted in FIG. 1, the computing system 100 may include an optimization server 102, a data store 106, a network 112, and a client device 123. The network 112 may include, for example, the Internet, intranets, extranets, wide area networks (WANs), local area networks (LANs), wired networks, wireless networks, cable networks, satellite networks, or other suitable networks, etc., or any combination of two or more such networks. The optimization server 102 may be used to host an optimization application 103.

The data store 106 may store various types of data related to client information, such as demographics data, risk tolerance measurement data, target parameter data, and other types of data. The data store 106 may also store product offerings data that have been matched or mapped to a client. The demographics data may include data such as current age, sex, current income, race, and other types of data related to client demographics provided by a client. Risk tolerance measurement data may be based on data provided by a client. For example, some clients may have a higher risk tolerance for certain resource placement vehicles than other clients. Even among the investment spectrum, which may range from lower risk investments such as bonds, bond portfolios, and mutual funds with planned termination dates to higher risk investments such as stocks, stock portfolios, and a range of mutual funds with indeterminate termination dates, some clients may have a preference for the higher risk investments over the lower risk investments, and vice-versa. Clients may be asked to provide preference for the higher risk investments and/or the lower risk investments in a quantifiable manner.

In some examples, clients may be able to provide data related to a current resource placement portfolio, and this data may be used to infer or determine the client's risk tolerance measurement. In some examples, the client may have their resource placement portfolios already managed by the entity providing the optimized cessation of resource acquisition guidance. In some examples, the risk tolerance measurement may correspond to a likelihood of success measurement for achieving a client's desired target parameters. For example, the likelihood of success may be measured based on feasibility of hitting a desired resource consumption metric upon cessation of resource acquisition for the client based on how much cessation of resource acquisition assets the client holds currently. The likelihood of success measurement may be a percentage and may have a range from approximately 60% to 95%. A likelihood of success measurement for a client that is closer to 95% may mean that there is a high likelihood that the client can achieve the desired resource consumption metric. A likelihood of success measurement for a client that is closer to 60% may mean that there is a low likelihood of the client achieving the desired resource consumption metric.

The target parameter data may include target cessation of resource acquisition data and may be different for each client. For example, a client may provide the target cessation of resource acquisition data which may include desired cessation of resource acquisition age, desired resource consumption metric upon cessation of resource acquisition, target annual resource consumption metric growth rate upon cessation of resource acquisition, among others. The target or desired resource consumption metric upon cessation of resource acquisition may correspond to the annualized income clients may wish to withdraw each year after their target cessation of resource acquisition age has been met. The target annual resource consumption metric growth rate upon cessation of resource acquisition may correspond to a growth percentage rate that clients desire for their investments for their post-retirement years. The growth percentage rate may be tied to outgrowing inflation percentage measured by a variety of factors, such as consumer price index (CPI) data, personal consumption expenditures (PCE) data, and other types of data. In some examples, clients may provide a specific desired growth percentage.

The target cessation of resource acquisition data a client may provide may also include a preference for investments as a first resource placement vehicle and a preference for annuities as a second resource placement vehicle. For example, some clients may prefer only investments and some clients may prefer only annuities. Clients may provide a ratio of annuities to investments in line with their preferences. Clients may additionally indicate until which age they would prefer solely investments and at what age they would prefer allocation in annuities. Clients may also indicate a predicted age of mortality as part of the target cessation of resource acquisition data.

Clients may provide the above-discussed data via the client device 123. The client device 123 is representative of one or more client devices that may be coupled to the network 112. The client device 123 may include, for example, a processor-based system such as a computer system. Such a computer system may be embodied in the form of a desktop computer, a laptop computer, personal digital assistants, cellular telephones, smartphones, tablet computer systems, or other devices. The client device 123 may include a display 126. The display 126 may include, for example, one or more devices such as liquid crystal display (LCD) displays, gas plasma-based flat panel displays, organic light emitting diode (OLED) displays, electrophoretic ink (E ink) displays, or other types of display devices, etc.

The entities described above may also be able to view client information via the client device 123. Additionally, the entities may also be able to input any notes or make any selections for clients via the client device 123.

The client device 123 may be configured to execute various applications such as a client application 132 and/or other applications. The client application 132 may be executed in the client device 123, for example, to access network content provided by the optimization application 103 and/or other applications or servers, thereby rendering a user interface 129 on the display 126 of the client device 123. To this end, the client application 132 may include, for example, a browser, a dedicated application, etc., and the user interface 129 may include a network page, an application screen, etc.

The optimization server 102 may include a server computer or any other system providing computing capability for the generation of duration-dependent hybrids. Alternatively, the optimization server 102 may employ a plurality of computing devices that may be arranged, for example, in one or more server banks or computer banks or other arrangements. Such computing devices may be located in a single installation or may be distributed among many different geographical locations. For example, the optimization server 102 may include a plurality of computing devices that together may comprise a hosted computing resource, a grid computing resource, and/or any other distributed computing arrangement. In some cases, the optimization server 102 may correspond to an elastic computing resource where the allotted capacity of processing, network, storage, or other computing-related resources may vary over time.

One or more applications (e.g., the optimization application 103) and/or other functionality may be executed in the optimization server 102 according to one or more embodiments. Also, various data stored in the data store 106 may be accessible to the optimization server 102. The data stored in the data store 106 is associated with the operation of the optimization application 103 and/or functional entities described below.

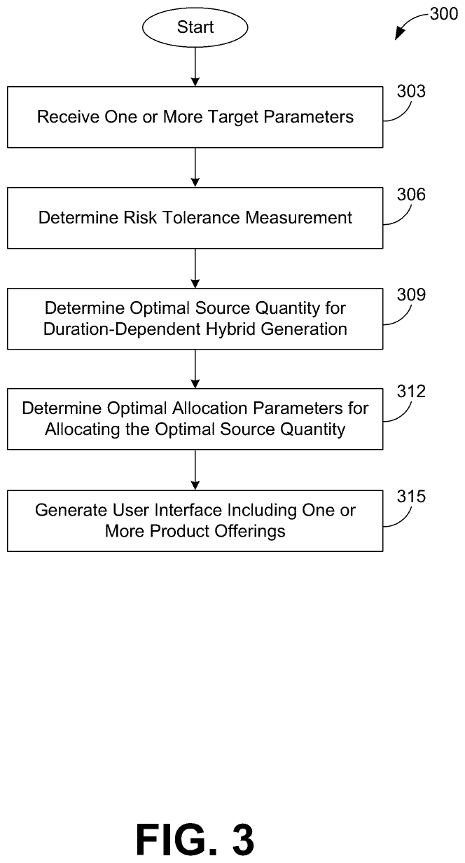

Based on the target cessation of resource acquisition data and the risk tolerance measurement data provided by a client, the optimization application 103 may be configured to provide various outputs including a duration-dependent hybrid for achieving the client's target parameters. For example, the optimization application 103 may be configured to output an optimal source quantity, which may be a numerical amount corresponding to the capital that may be required for achieving the client's desired annual resource consumption metric upon cessation of resource acquisition. For example, the optimization application 103 may output that the capital needed to achieve a $40,000 per year annual resource consumption metric upon cessation of resource acquisition for a client is $700,000, based on the different types of information provided by the client as part of the target cessation of resource acquisition data, the risk tolerance measurement data, the demographics data, and other types of data. More detailed examples associated with the generation of duration-dependent hybrids and their individual parameters are given with respect to the flowchart depicted in FIG. 3.

The optimization application 103 may further be configured to generate a plurality of other outputs such as allocation parameters for the optimal source quantity generated, which may include an optimized ratio of annuities and investments (e.g., 50% investments and 50% annuities) for allocating the source quantity, optimized annuity products to purchase, optimized investments to purchase, optimized annuity start dates (if applicable), etc. Outputs that the optimization application 103 may generate may be duration-dependent or duration-limited by the target cessation of resource acquisition data, the risk tolerance measurement data, the demographics data, and other types of data provided by clients. For example, if a client provided that a predicted age of mortality is 90 in contrast to 100, then the optimization application 103 may generate an optimal source quantity based on this information. For example, the optimal source quantity may be less for a client whose predicted age of mortality is 90 in contrast for a client whose predicted age of mortality is 100, with other variables being the same.

As described above, based on the target cessation of resource acquisition data, the risk tolerance measurement data, and other preferences indicated by a client, the optimization application 103 may provide dynamically updateable outputs, such as source quantities needed to achieve the client's target cessation of resource acquisition parameters, capital allocation parameters in investments and/or annuities for allocating the source quantities, an annuity start date (if applicable), a crossover point (age of the client) from investments to annuities, and other outputs. For example, if a client indicated a preference for strictly investments as part of the target cessation of resource acquisition parameters, the optimization application 103 may provide output values that correspond to the client's preferences. For example, if a client indicated a preference for strictly annuities or indicated a certain ratio of investments and annuities, the optimization application 103 may provide output values commensurate with these preferences.

The optimization application 103 may provide the different outputs described above based on stochastic calculus tools and machine-learning algorithms. The stochastic calculus tools and machine-learning algorithms may be rooted in principles behind horizon, risk, and longevity associated with different resource placement vehicles. For example, investment horizon may be defined as the amount of time an investor may be willing to hold resources in a particular portfolio. For cessation of resource acquisition, some resources may be held for nearby consumption and some may be held for distant consumption. The need for consumption may be decades away for some or next month for a retiree. When planning for consumption, a robust risk-mitigating strategy may include “duration matching,” which is the idea that an individual's investment horizon matches the point in time that one's assets may create cash flows. Assuming a fixed income portfolio, the point in time when one is ready to spend part of that portfolio is precisely the point in time when that portion of the portfolio matures.

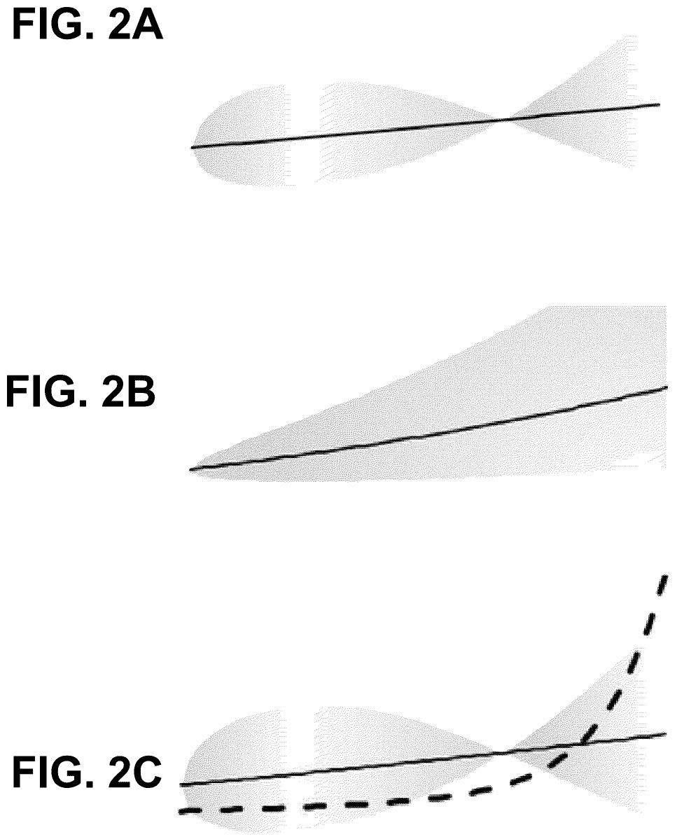

For example, FIG. 2A illustrates a stochastic model associated with an expected rate of return of bonds, according to one or more embodiments of the present disclosure. FIG. 2A illustrates the variety of prices at which bonds may be liquidated as it moves toward maturity. After maturity, the proceeds may be reinvested at a range of possible interest rates. The optimization application 103 may be configured to factor in that clients generally are not interested in placing large bets on changes in the yield curve and are best served with a risk-minimizing approach. In placing large bets on the yield curve, even sophisticated entities (e.g., Silicon Valley Bank) may miss. Examples of assets that fit in this category may include bonds, bond portfolios, and mutual funds with planned termination dates.

Risky investments or assets may have both ongoing risk and an expectation of return to compensate investors for that risk. Sometimes, this expectation of return may be termed sequence of return risk. The prevailing strategy for this class of assets may be that over long periods of time, they will generate returns similar to their historical averages. As such, risky assets may include stocks, stock portfolios, and a range of mutual funds with indeterminate termination dates. For short investment horizons, risky assets may be too risky to be prudent. Accordingly, riskier assets may generally be used for long investment horizons. FIG. 2B illustrates a stochastic model associated with an expected rate of return of risky assets, according to one or more embodiments of the present disclosure. FIG. 2B illustrates how the range of likely possibilities grows through time but the expected rate of return also drifts up.

Longevity risk may be defined as the risk of outliving saved retirement funds for an individual. Therefore, everyone runs the risk of a long life and should be financially prepared to survive to an advanced age. A wide array of products exist to hedge this risk in the form of annuities. However, in terms of liquidity and return, many of these products may not be attractive to prospective investors. However, annuity products such as deferred annuities may eventually dominate other investments in an resource placement portfolio at a certain age for an individual. FIG. 2C illustrates a stochastic model associated with an expected rate of return of annuities, according to one or more embodiments of the present disclosure. FIG. 2C compares an expected rate of return of an annuity (e.g., dotted line) to the expected rate of return of a bond (e.g., compare FIG. 2C to FIG. 2A). FIG. 2C illustrates that early on, the expected rate of return of the annuity is dominated by holding the bond to maturity. However, for cash flows at an advanced age, the annuity begins to dominate the expected rate of return of the bond in a fixed income portfolio.

The optimization application 103 may provide certain modules such as a data collection module 150, a data processing module 153, a training module 156, a machine-learning model 159, and a user interface module 162, and/or the like for performing certain tasks, such as identifying relationships between the client demographics data, the target parameter data, the risk tolerance measurement data, and other types of data which may be retrieved from the data store 106, for predicting duration-dependent hybrids.

The data collection module 150 may be configured to receive the data objects stored in the data store 106, such as the client demographics data, the target parameter data for a client, the risk tolerance measurement data for the client, and other types of data described in the preceding sections, according to one or more examples. The data collection module 150 may be configured to receive these data objects, so that the machine-learning model 159 can determine relationships between the different types of data to various duration-dependent hybrids that are generated as outputs to accurately predict suitable duration-dependent hybrids for some clients.

The data processing module 153 may be configured to process the data collected by the data collection module 150 and associate the client data described above with the various outputs that the optimization application may generate. As discussed previously, the optimization application 103 may generate various duration-dependent hybrids, which can include source quantities and allocation parameters for the source quantities for a client based on the associated demographics data, the target parameter data, and the risk tolerance measurement data. The data processing module 153 may associate the duration-dependent hybrids that are generated by the optimization application 103 to corresponding clients and further associate any selections made by the corresponding clients with respect to the duration-dependent hybrids through use of data tables, for example. Additionally, the data processing module 153 may be configured to perform any data cleaning steps to handle any outliers and inconsistencies in the data to ensure that the received data is accurate and reliable for training.

In some embodiments, the data processing module 153 may be configured to generate a data structure 163. The data structure 163 may include results of the associations and mappings between inputs and outputs described above. For example, once the optimization application 103 generates a duration-dependent hybrid for a client, these results may be saved in a table in the data structure 163, so that mappings between a client and actual outcomes of duration-dependent hybrids are accessible by the training module 156 and/or the machine-learning model 159.

The training module 156 may provide learning, or training to the machine-learning model 159 by providing training data (e.g., data from other modules that contains inputs such as stage inputs and known outcomes, to allow the machine-learning model 159 to learn over time. For example, the training module 156 may receive data from the data structure 163 and data from the data store 106 and provide the received data to the machine-learning model 159. The training module 156 may conduct the training in any suitable manner such as in batches, and may include any suitable training methodology. Training may be performed periodically and/or continuously (e.g., in real-time or near real-time). Further details of training a machine-learning model are provided below.

The machine-learning model 159 may be configured to receive the training data from the training module 156 to learn relationships between the duration-dependent hybrids that are generated and their associations to clients based at least in part on client information such as the demographic data, the risk tolerance measurement data, and the target parameter data specified by the clients. For example, the machine-learning model 159 may be configured to use programmed algorithms for identifying the above-mentioned relationships. The data processing module 153 may map the source quantities and the allocation parameters obtained as outputs to the different characteristics associated with the client, as determined by the different data objects stored in the data store 106. The machine-learning model 159 may be configured to identify the relationships described above and predict which duration-dependent hybrids certain clients are likely to accept, given their informational profile. The ordering of the training data may be randomized during training. The machine-learning model 159 may visualize the training data to identify relevant relationships between different variables and identify any data imbalances. The training data may be split into two parts where one part is for training the model and the other part is for validating the trained model, de-duplicating, normalizing, correcting errors in the training data, and so on. In some examples, the machine-learning model 159 may be configured to receive data directly from the data structure 163. The machine-learning model 127 may implement various machine-learning techniques (e.g., random forest, k-nearest neighbor, partial least squares regression, principal component regression, etc.) discussed in the present disclosure.

The user interface module 162 may enable a presentation of a graphical user interface (GUI) in a user device, for a user of the optimization server 102. The user interface module 162 may include a variety of interfaces, for example, interfaces for data input and output devices, referred to as I/O devices, storage devices, and the like.

FIG. 3 depicts an exemplary method 300 for duration-dependent hybrid generation, according to one or more embodiments of the present disclosure. The method 300 may be used for determining an optimal source quantity to meet a client's target parameters and for determining allocation parameters for the optimal source quantity in a plurality of vehicles. The optimization application 103 may be configured to execute the method 300 according to various embodiments.

At step 303, the optimization application 103 may be configured to receive one or more target parameters from a client. The one or more target parameters may include target cessation of resource acquisition parameters associated with the client. For example, the client may provide to the optimization application 103 one or more inputs that the optimization application 103 may use in generating a duration-dependent hybrid for the client. As an example, reference is given to the table below:

TABLE 1
Inputs
Inputs Screen #1

| | | |
|---|---|---|
| User | Current Age (static) | 50 |
| | Retirement Income (Today) | 50,000 |
| | Growth Rate | 5.00% |
| | Retirement Age | 70 |
| | Likelihood of Success | 90% |
| | Portfolio (Equity/Bonds) | 20/80 |

Table 1 is provided for exemplary purposes only and should not be construed to limit the disclosure in any way. As can be seen above, the client may provide a current age, a desired resource consumption metric upon cessation of resource acquisition (e.g., retirement income), a desired growth rate of the desired resource consumption metric, a desired cessation of resource acquisition age (e.g., retirement age), and a desired allocation distribution. The desired resource consumption metric may correspond to the annual income (in dollars or other currencies) the client may wish to withdraw yearly once reaching the desired cessation of resource acquisition age, in today's dollars.

The desired allocation distribution may be an optional preference that the client provides for the optimization application 103. For example, the client may provide a percentage allocation preference for a first resource placement vehicle (e.g., investments such as bonds, stocks, mutual funds, etc.) and a second resource placement vehicle (e.g., annuities such as fixed annuities, variable annuities, indexed annuities, deferred annuities, etc.) or a blend of the first resource placement vehicle and the second resource placement vehicle. For example, the client may indicate a preference for 100% investments or 100% annuities, or 50% investments and 50% annuities. The client may even indicate until what age the client prefers investments over annuities and additionally indicate what type of investments (e.g., bonds, stocks, etc.) are preferred.

Additionally, although not shown in Table 1, the client may provide a predicted age of mortality as part of the target cessation of resource acquisition data. For example, the client may indicate preference for the optimization application 103 to make projections until a specified age of mortality as inputted by the client. For example, the client may indicate that the desired annual resource consumption metric upon cessation of resource acquisition may only be needed to a certain age (e.g., age 100). In some cases, the client may not provide any predicted age of mortality.

The data provided by the client in step 303 may be input through a user interface in a computing device. For example, the client may provide the above-mentioned data via the user interface 129 of the client device 123. The provided data may be stored in the data store 106.

At step 306, the optimization application 103 may be configured to determine a risk tolerance measurement for the client. The risk tolerance measurement may correspond to a likelihood of success measurement. For example, the likelihood of success may be measured based on feasibility of achieving a desired resource consumption metric for the client based on how much cessation of resource acquisition assets the client holds currently. In additional examples, the optimization application 103 may be configured to determine the risk tolerance measurement for the client based on an analysis of the client's existing resource placement portfolio. For example, the optimization application 103 may be configured to infer a risk tolerance measurement based on capital allocation characteristics of the existing portfolio, value of the existing portfolio, and other factors. These factors can include a wide variety of both investment constraints (i.e., the prudent man rule, boundaries on investment factor exposure, balance between 1/n optimization versus mean-variance optimization, constraints on the percentage of the corpus in annuities, etc.) and measures of risk tolerance (i.e., data-mining techniques from individual investor behaviors, prospect theory-based measures, etc.).

At step 309, the optimization application 103 may be configured to determine an optimal source quantity for duration-dependent hybrid generation for the client. As discussed previously, the duration-dependent hybrid may include an optimal source quantity and allocation parameters for allocating the optimal source quantity. The optimization application 103 may generate the optimal source quantity based on the data provided by the client in step 303 and/or the risk tolerance measurement determined in step 306. The optimal source quantity may correspond to an output generated by the optimization application 103. The optimal source quantity may correspond to a resource value required by the client to achieve the one or more target parameters provided at step 303. To illustrate, reference is given to Table 2 provided below:

TABLE 2
Outputs
Output Screen #1

| | | |
|---|---|---|
| User | Inv. + Ann. | $697,916 |
| | Ann. Age | 79 |
| | % Ann. | 50% |
| | % Inv. | 50% |
| | Annuity | $348,958 |
| | Investments | $348,958 |

Table 2 is provided for exemplary purposes only and should not be construed to limit the disclosure in any way. In a non-limiting example, the optimization application 103 may determine that the optimal source quantity for achieving the one or more target parameters specified at steps 303 and 306 (e.g., see Table 1) is $697,916. The optimal source quantity may be determined based on, for example, the current age, the desired cessation of resource acquisition age, the likelihood of success measurement, the desired growth rate, the predicted age of mortality, and/or the desired allocation distribution between investments and annuities or between individual assets of investments or annuities.

The optimization application 103 may further determine the optimal source quantity based on stochastic models corresponding to investment horizon, risk, and longevity. For example, the stochastic models depicted in FIGS. 2A-2C may be used to derive the optimal source quantity based on the one or more target cessation of resource acquisition parameters provided at step 303 and/or the risk tolerance measurements determined at step 306. The optimization and determination of the optimal source quantity may be calculated algorithmically by comparing the most economically efficient means of creating each year's income under the risk tolerance constraints. The algorithm(s) may include any type of discrete data point robust root finding method (i.e., Newton-Raphson or even brute force methods, etc.).

At step 312, the optimization application 103 may be configured to determine optimal allocation parameters for the source quantity determined at step 309. The optimal allocation parameters may be determined based on the client's target cessation of resource acquisition parameters received at step 303 and/or the risk tolerance measurement determined at step 306. The optimization application 103 may be configured to generate a plurality of outputs corresponding to the optimal allocation parameters in the form of investments, annuities, and/or investments and annuities.

Referring back to Table 2, the optimization application 103 may determine that the optimal way to allocate the source quantity of $697,916 is 50% investments and 50% annuities. The optimization application 103 may further determine that, for the annuities allocation, the optimal annuity start date (e.g., corresponding to deferred annuities) is at age 79. According to this example, the optimal allocation for annuities and investments may each be $348,958.

In some examples, the optimization application 103 may generate the optimal allocation based on the desired allocation distribution provided by the client at step 303. For example, the client may indicate that the maximum allocation of annuities desired is 50%, which may enable the optimization application 103 to generate the allocation parameters of 50% investments and 50% annuities as described above. In another example, the client may indicate that the maximum allocation of annuities desired is 20%. Based on this preference, the optimization application 103 may adjust the determination of the optimal source quantity and/or the optimal allocation parameters accordingly.

In some examples, the optimization application 103 may determine allocation parameters for investments as the only available resource placement vehicle and annuities as the only available resource placement vehicle. The optimization application 103 may be configured to determine the optimal allocation parameters based on the stochastic models depicted in FIGS. 2A-2C. Based on the expected rate of return of each model, the optimization application 103 may optimally determine different resource placement vehicles to allocate the optimal source quantity determined at step 309 for investments only, annuities only, or a blend of investments and annuities.

For the blend of investments and annuities, the optimization application 103 may be configured to determine a crossover point from investments to annuities for the client as part of the optimal allocation parameters. For example, based on the stochastic models depicted in FIGS. 2A-2C, the optimization application 103 may determine an optimal age for when the client should allocate at least a part of the determined source quantity in annuities. In some embodiments, the optimization application 103 may determine the crossover point based on machine-learning models such as the machine-learning model 159. The optimization application 103 may further determine an optimal annuity start date (i.e., when the client should start receiving payments from the purchased annuity) for any purchased annuities.

The optimization application 103 may further be configured to determine a model portfolio as part of the optimal allocation parameters. For example, once the optimization application 103 determines that the optimal source quantity should be allocated with a certain percentage to investments and a certain percentage to annuities, the optimization application 103 may further be configured to determine specific assets or annuities that should be purchased. The optimization application 103 may be configured to use a variety of investment and annuity databases that may be customized based on advisory processes, including connecting directly with CANNEX to obtain latest annuity premiums and ratings from all annuity carriers in the United States. The optimal allocation parameters may further be determined based on comparison between each type of resource placement vehicle under the stochastic confidence interval constraints derived from the set of risk tolerance inputs.

In some embodiments, the optimization application 103 may rely on the machine learning model 159 to predict the optimal source quantity and the optimal allocation parameters for a client. For example, the machine-learning model 159 may be trained to identify relationships between certain inputs (e.g., client demographics, target parameters, risk tolerance measurements, etc.) and outputs (e.g., optimal source quantity, optimal allocation parameters, etc.), as discussed with respect to the individual modules described for FIG. 1. In this respect, the execution of the machine learning model 159 may include deployment of one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

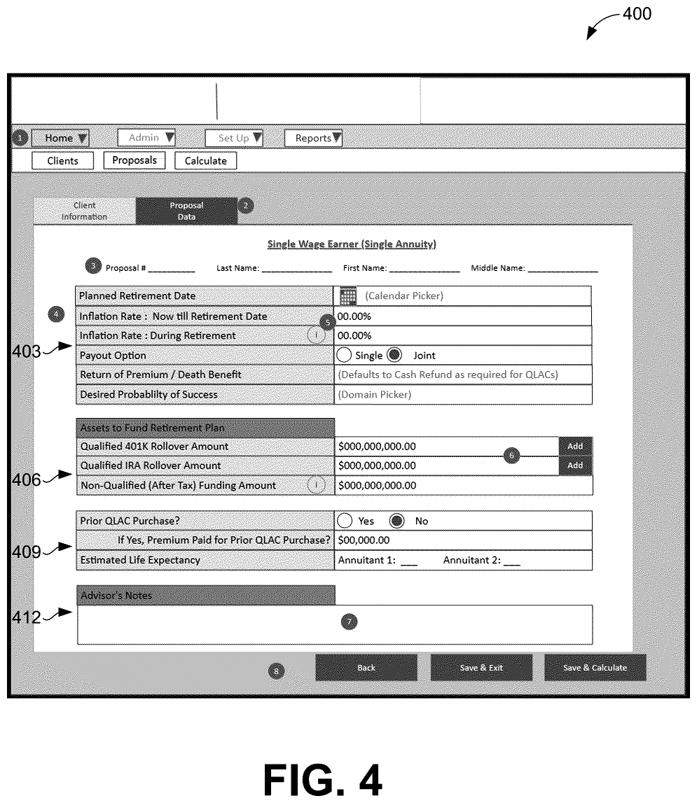

At step 315, the optimization application 103 may be configured to generate user interfaces that include the outputs determined at steps 309 and 312. The outputs may be included in the user interfaces such as the user interface 129 of the client device 123 in the form of product offerings, whereby the client may be able to choose between multiple product offerings generated by the optimization application 103. Examples of user interfaces that may be generated by the optimization application 103 are illustrated with respect to FIGS. 4-6.

FIG. 4 depicts an example user interface rendered on a client device, according to one or more embodiments of the present disclosure. A user interface 400 may be rendered on the client device 123 and may be used by the entities (e.g., advisors, institutions, etc.) or their clients for providing client information to the optimization application 103. The user interface 400 may include various input fields 403, where clients may provide one or more target cessation of resource acquisition data, as outlined in step 303 for method 300. For example, the entities or their clients may be able to provide in the input fields 403 a planned cessation of resource acquisition date, various inflation rates (e.g., corresponding to the desired growth rates discussed at step 303 for method 300), payout options to single or joint accounts, a return of premium for annuity products in case of mortality, and a desired probability of success (e.g., corresponding to the likelihood of success measurement discussed at step 306 for method 300).

The user interface 400 may include various input fields 406, where clients may provide a qualified 401K rollover amount data, qualified IRA rollover amount data, and/or non-qualified (after tax) funding amount data. The user interface 400 may further include various input fields 409, where clients may provide information about prior about qualified longevity annuity contract (QLAC) data, and estimated life expectancy data (e.g., corresponding to the predicted age of mortality discussed at step 306 for method 300). Additionally, the user interface 400 may include an input field 412, where the entities may input any notes about a client. The information provided in the user interface 400 may be stored in the data store 106.

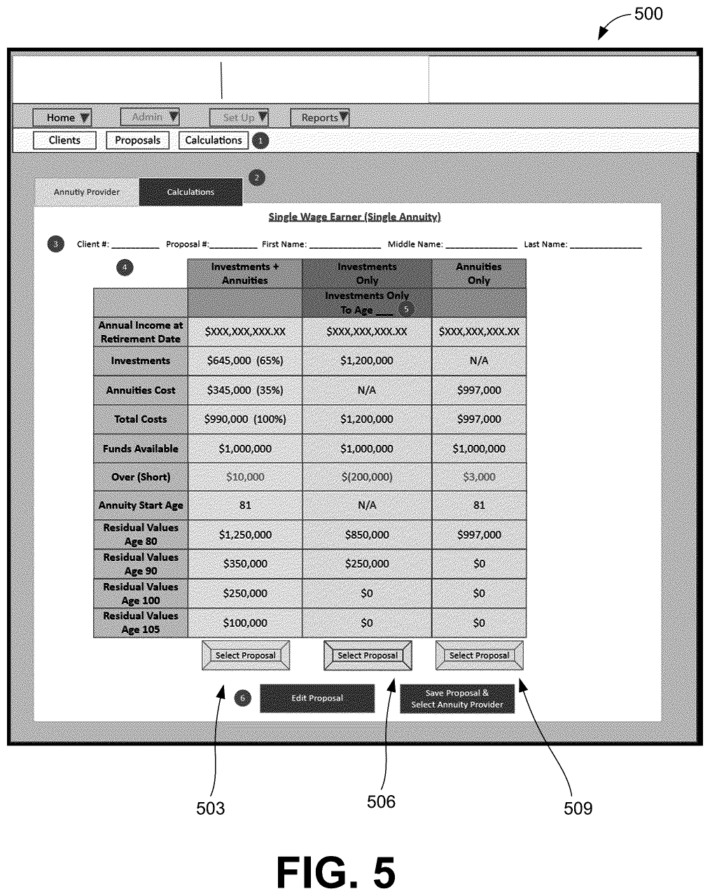

FIG. 5 depicts another example user interface 500 rendered on a client device, according to one or more embodiments of the present disclosure. A user interface 500 may be rendered on the client device 123 to provide product offerings to clients based on calculations performed according to steps 306, 309, and 312. For example, after the risk tolerance measurements according to step 306 (method 300), the optimal source quantity according to step 309 (method 300), and the optimal allocation parameters according to step 312 (method 300), are determined, the optimization application 103 may provide various product offerings 503, 506, and 509 to a client.

For example, the product offering 503 may include an optimal source quantity of $990,000 with optimal allocation parameters of 65% in investments and 35% in annuities. As discussed previously, the optimal allocation parameters may be determined based on client preference indicated in the target cessation of resource acquisition data (e.g., step 303 of method 300) and/or may be automatically determined by the optimization application 103 based on stochastic models or machine-learning algorithms.

The product offering 506 may also be provided if a client indicated in the target cessation of resource acquisition data (e.g., step 303 of method 300) a desired allocation distribution of 100% investments and no annuities. The product offering 506 may indicate until what age the client prefers investments only based on the data provided in the target cessation of resource acquisition data. The product offering 506 may include an optimal source quantity of $1,200,000 with full allocation towards investments.

The product offering 509 may also be provided if a client indicated in the target cessation of resource acquisition data (e.g., step 303 of method 300) a desired allocation distribution of 100% annuities and no investments. The product offering 509 may include an optimal source quantity of $997,000 with full allocation towards annuities. As can be seen in FIG. 5, the optimal source quantities for the product offerings 503, 506, and 509 may be different based on allocation preferences indicated by a client. Of the three product offerings 503, 506, and 509, the product offering of 503 may require the lowest total cost from the client. This may result from the optimization application 103 being able to consider both investments and annuities for calculations, enabling the optimization application 103 being able to generate product offerings with the lowest total cost.

The product offerings 503 and 509 may show an annuity start date, which may be determined by the optimization application 103. Each of the product offerings 503, 506, and 509 may additionally show residual values of the projected portfolio up to applicable ages. For the product offering 503, the client is expected to have $100,000 in resources remaining at age 105. For the product offering 506, the client is expected to run out of resources by age 100. For the product offering 509, the client is expected to run out of resources by age 90.

It should be noted that the product offerings 506 and 509 may be displayed as available options to the client even though the client did not indicate preference for investments only or annuities only at step 303 of method 300.

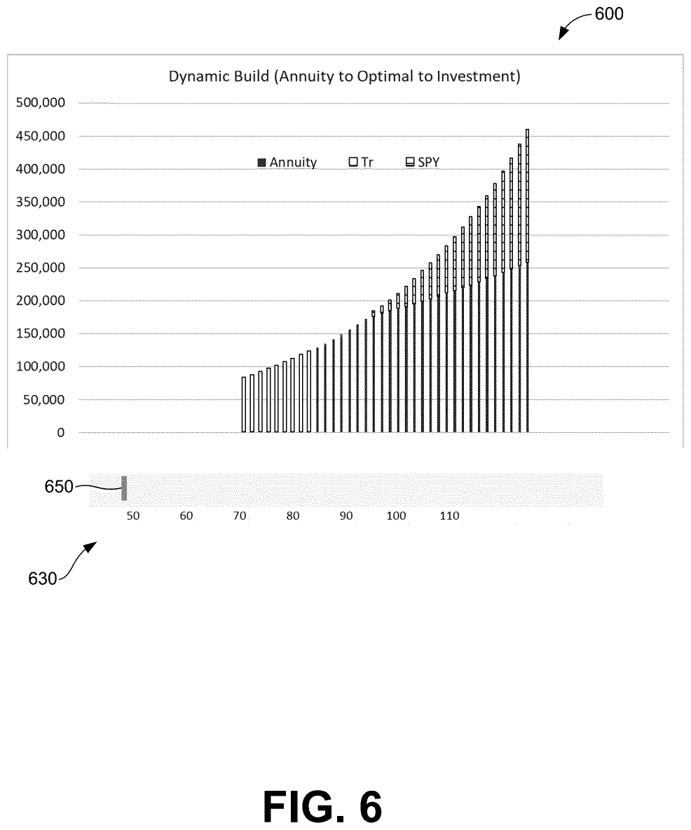

FIG. 6 depicts an interactive chart 600 that may be dynamically updated with a scroll bar, according to one or more embodiments of the present disclosure. The interactive chart 600 may be rendered in the user interface 129 of the client device 123. The interactive chart 600 may additionally be rendered in the user interface 500, so that a client may view the interactive chart 600 while reviewing the product offerings 503, 506, and 509. The interactive chart 600 may be illustrative of how a portfolio value starting with the optimal source quantity and the optimal allocation parameters may change over time. For example, the interactive chart 600 may illustrate a projected portfolio value determined for a client in association with selection of one or more of the product offerings 503, 506, and 509. The interactive chart 600 may illustrate the various allocations of the optimal source quantity (e.g., $50,000 to $500,000 in annuities, treasuries, and/or mutual fund index (e.g., SPY)) with selections of one or more of the product offerings 503, 506, and 509.

The interactive chart may be associated with a scroll bar 630. The entities and/or their clients may engage the scroll bar 630 by dragging vertical bar 650 in a horizontal direction, which may update projected portfolio values and allocations based on calculations by the optimization application 103. Dragging the vertical bar 650 in a horizontal direction may dynamically update the interactive chart 600 and show how a portfolio of a client is projected to change over an age duration.

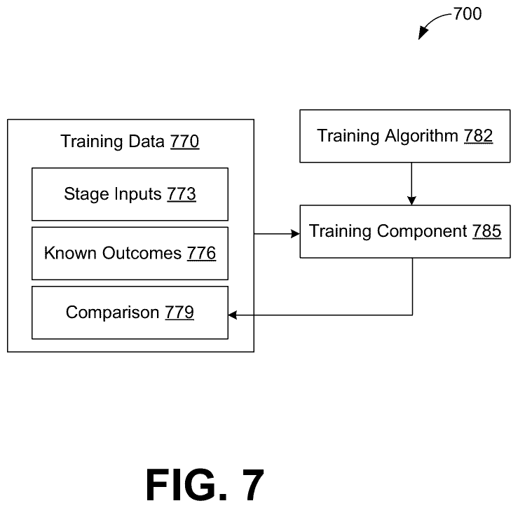

FIG. 7 depicts an example machine-learning training flow chart 700, according to one or more embodiments of the present disclosure. Referring to FIG. 7, a given machine-learning model (e.g., the machine-learning model 159) may be trained using the training flow chart 700. The training data 770 includes one or more of stage inputs 773 and the known outcomes 776 related to the machine-learning model to be trained. The stage inputs 773 may be from any applicable source including text, visual representations, data, values, comparisons, and stage outputs, e.g., one or more outputs from one or more steps from FIG. 3. The known outcomes 776 may be included for the machine-learning models generated based on supervised or semi-supervised training, or based on known labels, such as topic labels. An unsupervised machine-learning model may not be trained using the known outcomes 776. The known outcomes 776 may include known or desired outputs for future inputs similar to or in the same category as the stage inputs 773 that do not have corresponding known outputs.

The training data 770 and a training algorithm 782, e.g., one or more of the modules implemented using the machine-learning model and/or used to train the machine-learning model, may be provided to a training component 785 that may apply the training data 770 to the training algorithm 782 to generate the machine-learning model. According to an implementation, the training component 785 may be provided comparison results 779 that compare a previous output of the corresponding machine-learning model to apply the previous result to re-train the machine-learning model. The comparison results 779 may be used by the training component 785 to update the corresponding machine-learning model. The training algorithm 782 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine-learning model used herein may be trained and/or used by adjusting one or more weights and/or one or more layers of the machine-learning model. For example, during training, a given weight may be adjusted (e.g., increased, decreased, removed) based on training data or input data. Similarly, a layer may be updated, added, or removed based on training data/and or input data. The resulting outputs may be adjusted based on the adjusted weights and/or layers.

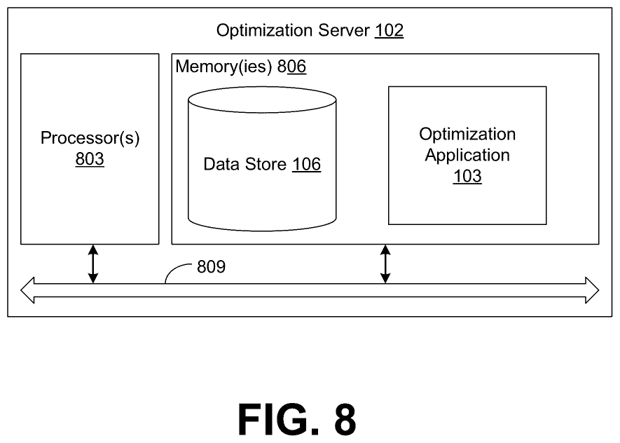

FIG. 8 is a schematic block diagram that provides one example illustration of the optimization server of FIG. 1, according to one or more embodiments of the present disclosure. The optimization server 102 includes at least one processor circuit, for example, having a processor 803 and a memory 806, both of which are coupled to a local interface 809. To this end, the optimization server 102 may comprise, for example, at least one server computer or like device. The local interface 809 may comprise, for example, a data bus with an accompanying address/control bus or other bus structure as can be appreciated.

Stored in the memory 806 are both data and several components that are executable by the processor 803. In particular, stored in the memory 806 and executable by the processor 803 is the optimization application 103, and potentially other applications. Also stored in the memory 806 may be the data store 106 and other data. In addition, an operating system may be stored in the memory 806 and executable by the processor 803.

It is understood that there may be other applications that are stored in the memory 806 and are executable by the processor 803 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 806 and are executable by the processor 803. In this respect, the term “executable” means a program file that is in a form that can ultimately be run by the processor 803. Examples of executable programs may be, for example, a compiled program that can be translated into machine code in a format that can be loaded into a random access portion of the memory 806 and run by the processor 803, source code that may be expressed in proper format such as object code that is capable of being loaded into a random access portion of the memory 806 and executed by the processor 803, or source code that may be interpreted by another executable program to generate instructions in a random access portion of the memory 806 to be executed by the processor 803, etc. An executable program may be stored in any portion or component of the memory 806 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 806 is defined herein as including both volatile and nonvolatile memory and data storage components. Volatile components are those that do not retain data values upon loss of power. Nonvolatile components are those that retain data upon a loss of power. Thus, the memory 806 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 803 may represent multiple processors 803 and/or multiple processor cores, and the memory 806 may represent multiple memories 806 that operate in parallel processing circuits, respectively. In such a case, the local interface 809 may be an appropriate network that facilitates communication between any two of the multiple processors 803, between any processor 803 and any of the memories 806, or between any two of the memories 806, etc. The local interface 809 may comprise additional systems designed to coordinate this communication, including, for example, performing load balancing. The processor 803 may be of electrical or of some other available construction.

Although the optimization application 103, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 3 shows the functionality and operation of an implementation of portions of the optimization application 103. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 803 in a computer system or other system. The machine code may be converted from the source code, etc. If embodied in hardware, each block may represent a circuit or a number of interconnected circuits to implement the specified logical function(s).

Although the flowchart of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. Further, in some embodiments, one or more of the blocks shown in FIG. 3 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the optimization application 103, that comprises software or code can be embodied in any non-transitory computer-readable medium for use by or in connection with an instruction execution system such as, for example, a processor 803 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A computer-implemented method, comprising:
receiving, by one or more processors, one or more target parameters associated with a client, the one or more target parameters being based at least in part on one or more factors;
determining, by the one or more processors, a risk tolerance measurement for the client associated with achieving the one or more target parameters;
determining, by the one or more processors, an optimal source quantity associated with achieving the one or more target parameters based on the risk tolerance measurement;
determining, by the one or more processors, optimal allocation parameters for allocating the optimal source quantity; and
generating, by the one or more processors, a user interface comprising one or more duration-dependent hybrids, the one or more duration-dependent hybrids comprising one or more product offerings based at least in part on the optimal source quantity and the optimal allocation parameters.

2. The computer-implemented method of claim 1, wherein the one or more target parameters include one or more of:
a desired cessation of resource acquisition age of resource acquisition cessation;
a desired annual resource consumption metric; or
a desired growth rate of the desired annual resource consumption metric.

3. The computer-implemented method of claim 1, wherein determining the optimal allocation parameters further comprises determining whether to allocate the optimal source quantity in one or more of a plurality of vehicles, the plurality of vehicles including a first vehicle and a second vehicle, the first vehicle corresponding to one or more investment categories and the second vehicle corresponding to one or more annuity categories.

4. The computer-implemented method of claim 3, further comprising:
determining, by the one or more processors, an optimized annuity start date for the second vehicle based on achieving the one or more target parameters.

5. The computer-implemented method of claim 3, wherein the optimal allocation parameters include allocating the optimal source quantity in the first vehicle and the second vehicle, the method further comprising:
determining, by the one or more processors, a crossover point from the first vehicle to the second vehicle.

6. The computer-implemented method of claim 5, wherein determining the crossover point is further based at least in part on one or more stochastic models associated with the plurality of vehicles.

7. The computer-implemented method of claim 5, wherein determining the crossover point is further based at least in part on one or more machine-learning models.

8. The computer-implemented method of claim 3, wherein at least one of the one or more product offerings includes a plurality of user interface objects associated with display of an optimized ratio of the first vehicle and the second vehicle.

9. The computer-implemented method of claim 3, wherein at least one of the one or more product offerings is based only on the first vehicle.

10. The computer-implemented method of claim 3, wherein at least one of the one or more product offerings is based only on the second vehicle.

11. The computer-implemented method of claim 3, wherein the user interface includes a chart illustrating a projected growth of the optimal source quantity, wherein the chart is visually updateable based at least in part on engagement of a scroll bar.

12. The computer-implemented method of claim 1, wherein the risk tolerance measurement is determined based at least in part on a risk tolerance value implied by an existing resource placement portfolio of the client.

13. The computer-implemented method of claim 1, wherein the risk tolerance measurement is determined based on calculations associated with feasibility of achieving the one or more target parameters based at least in part on a resource quantity available to the client.

14. The computer-implemented method of claim 1, wherein the optimal source quantity and the optimal allocation parameters are further determined based on a machine-learning algorithm.

15. A system, comprising:
at least one memory comprising processor-readable instructions stored therein; and
one or more processors configured to access the at least one memory and execute the processor-readable instructions to perform operations, the operations comprising:
receiving one or more target parameters associated with a client, the one or more target parameters being based at least in part on one or more factors;
determining a risk tolerance measurement for the client associated with achieving the one or more target parameters;
determining an optimal source quantity associated with achieving the one or more target parameters based on the risk tolerance measurement;
determining optimal allocation parameters for allocating the optimal source quantity; and
generating a user interface comprising one or more duration-dependent hybrids, the one or more duration-dependent hybrids comprising one or more product offerings based at least in part on the optimal source quantity and the optimal allocation parameters.

16. The system of claim 15, wherein the optimal source quantity and the optimal allocation parameters are further determined based at least in part on a machine-learning algorithm.

17. The system of claim 15, wherein determining the optimal allocation parameters further comprises determining whether to allocate the optimal source quantity in one or more of a plurality of vehicles, the plurality of vehicles including a first vehicle and a second vehicle, the first vehicle corresponding to one or more investment categories and the second vehicle corresponding to one or more annuity categories.

18. The system of claim 17, wherein the optimal allocation parameters include allocating the optimal source quantity in the first vehicle and the second vehicle, the operations further comprising:
determining a crossover point from the first vehicle to the second vehicle.

19. A non-transitory computer-readable medium storing a set of instructions that, when executed by one or more processors, cause the one or more processors to perform operations, the operations comprising:
receiving one or more target parameters associated with a client, the one or more target parameters being based at least in part on one or more factors;
determining a risk tolerance measurement for the client associated with achieving the one or more target parameters;
determining an optimal source quantity associated with achieving the one or more target parameters based on the risk tolerance measurement;
determining optimal allocation parameters for allocating the optimal source quantity; and
generating a user interface comprising one or more duration-dependent hybrids, the one or more duration-dependent hybrids comprising one or more product offerings based at least in part on the optimal source quantity and the optimal allocation parameters.

20. The non-transitory computer-readable medium of claim 19, wherein determining the optimal allocation parameters further comprises determining whether to allocate the optimal source quantity in one or more of a plurality of vehicles, the plurality of vehicles including a first vehicle and a second vehicle, the first vehicle corresponding to one or more investment categories and the second vehicle corresponding to one or more annuity categories.
